(19) United States
(12) Patent Application Publication
(10) Pub. No.: US 2015/0261644 A1
(43) Pub. Date: Sep. 17, 2015

(54) Energy Efficiency Application System and Method of its Use for Empowering Consumers to Perform Energy Usage Audit at Home via Energy Data Aggregation of Electronic Appliances and Devices

(71) Applicant: THE REGENTS OF THE UNIVERSITY OF CALIFORNIA, Oakland, CA (US)

(72) Inventors: Yang Arthur Zhang, Irvine, CA (US); Guann Pyng Li, Irvine, CA (US); Dawei Ouyang, Irvine, CA (US)

(21) Appl. No.: 14/435,527

(22) PCT Filed: Oct. 9, 2013
(86) PCT No.: PCT/US2013/064096

§ 371 Date: Apr. 14, 2015

Related U.S. Application Data
(60) Provisional application No. 61/714,063, filed on Oct. 15, 2012.

(51) Int. Cl. G06F 11/30; G06F 11/32

(52) U.S. Cl. CPC G06F 11/3062; G06F 11/324

(57) ABSTRACT

A method of enabling a user of a power consuming devices to acquire energy consumption knowledge includes the steps of identifying a user communicating with a database, associating a physical and virtual environment of power consuming devices with the identified user, retrieving power consumption data with existing product information from the database, displaying to the user data of power consumption of a plurality of physical and virtual devices in the associated physical and virtual environment based on the current status of each device, and providing closed-loop feedback from the user to promote energy efficient devices and usage behavior of the user in the associated physical and virtual environment.

### RELATED APPLICATIONS

The present application is related to U.S. Provisional Patent Application, Ser. No. 61/714,063 filed on Oct. 15, 2012, which is incorporated herein by reference and to which priority is claimed pursuant to 35 USC 119.

### BACKGROUND

1. Field of the Technology

The disclosure relates to a system and method to control devices and display their information over a network and to present energy consumption data in a physical-virtual environment consisting of actual electronic appliances and devices, or their virtual representations.

2. Description of the Prior Art

Over 3 billion consumer electronics devices and appliances, also called plug loads, contribute to over 10% of the U.S. residential electricity usage. This percentage is expected to reach 40% by 2030, as more devices are introduced to the market. These plug load devices, although negligible in individual energy demand, collectively pose major challenges to implement future sustainability plans, such as California's Zero Net Energy (ZNE) initiative. The first challenge is to effectively monitor or estimate plug load portfolio for individual users. Consumers exhibit unique usage patterns of their own plug load devices. The second challenge is to effectively educate consumers of the availability of more efficient products and solutions. Energy efficiency has become the third most important criterion for consumers to make purchase decisions. However the relatively weak consumer operational knowledge of new technologies hinders mass conversion. Lastly, government agencies and utility companies face the challenge of predicting actual savings of efficient solutions and designing the optimal incentive programs to drive adoption.

Hundreds of energy management systems have been invented for commercial buildings and residential houses, Wired and wireless metering and controlling accessories are also booming. Utilities have installed over 22 million smart meters across the nation by 2013. Major appliance manufacturers have begun roiling out Smart meter compatible platforms such as the latest LG ThinQ™ and Samsung PlanetFirst™.

However, the distributed nature of consumer electronics is not well addressed in commercial and governmental incentive programs. It is very hard for individual consumers to justify purchase of more efficient products when economic incentives are the only leverage. Green, ecologically friendly activists and organizations have failed at creating a collective conversion for a new energy efficient lifestyle. Aligning people's goodwill and economics is the key.

### BRIEF SUMMARY

The “Wall of Power” (Wall of Power) is an innovative method and apparatus for residential plug load monitoring and planning based on the concept of “Personal Energy Footprint” (PEF). The PEF refers to the energy needed for an individual to utilize plug load devices to support his/her daily activities such as doing the work, having entertainment, preparing food, etc. To achieve the ZNE goal, one needs to emphasize the energy consumption attributed from both personal and building energy footprints.

The illustrated embodiments of the invention present energy consumption data in a physical-virtual environment consisting of actual electronic appliances and devices, or their virtual representations. Users interact with the physical-virtual environment while gaining energy consumption knowledge on various choices of electronic appliances and devices. Users have option to submit voluntary device usage data to a self-aggregating database supporting the physical-virtual front end. The database system and server provides users with information for more energy efficient appliances and devices.

A display of a physical-virtual environment showing energy consumption with selected electrical devices and appliances is called, The “Wall of Power” The Wall of Power provides interactive consumer education on plug load devices and various systems' energy consumptionPersonal mobile devices, as a voluntary, non-intrusive plug load monitoring tool, provide quantitative evaluation of PEF. The PEF is displayed in The Wall of Power environment for users to understand the energy impact of all the plug load devices being used on a daily basis.

To encompass the rapidly evolving categories of consumer electronic products, an open database has been constructed for users to retrieve information on electronics products, energy consumption data, and incentive programs as well as user submitted data. It also recommends more energy efficient technologies and alternative products.

More particularly the illustrated embodiments of the invention include a system for managing and viewing dynamic energy usage information using an internet communicated to a database having energy consumption data of a plurality of devices or appliances stored therein. The system includes a front end which in turn includes a screen on which a display of a plurality of graphical representations of energy consumed by a corresponding plurality of plug load devices is projected, a projector for projecting the plurality of graphical representations onto the screen, a router communicated to the internet and to the projector, an energy management system (EMS) interface coupled to the router, and at least one plug load device or appliance coupled to, monitored and/or controlled by the energy management system (EMS) interface. The system includes a mobile communication device communicated by the internet to the database for controlling the front end.

The energy management system (EMS) interface further includes at least one of the means to communicate with plug load devices, such as powerline modem or communication protocol interface, Wifi and ZigBee radio coupled to at least one plug load device or appliance.

The system further includes at least one virtual device or appliance simulated as if coupled to the energy management system (EMS) interface. These virtual devices may be displayed in the Wall of Power environment or on a plurality of monitors and display devices.

The illustrated embodiment of the system includes a plurality of plug load devices or appliances are coupled to, monitored and/or controlled by the energy management system (EMS) interface and/or a plurality of virtual devices or appliances simulated as if coupled to the energy management system (EMS) interface, both.

The mobile communication device is communicated by the internet to the database for uploading into the database consumer initiated voluntary submissions of data relating to power usage.

The illustrated embodiments also include a method of enabling a user of a power consuming devices to acquire energy consumption knowledge including the steps of identifying a user communicating with a database, associating a physical and virtual environment of power consuming devices with the identified user, retrieving power consumption data with existing product information from the database, displaying to the user data of power consumption of a plurality of physical and virtual devices in the associated physical and virtual environment based on the current status of each device, and providing closed-loop feedback or interactive communication with the user to promote energy efficient devices and usage behavior of the user in the associated physical and virtual environment.

The database is an open database and the users provide usage and device information to the database voluntarily.

The database is an open database and device power consumption data is obtained from public and commercial sources.

The method further includes the step of providing an energy consumption estimation at a household level combining real time energy data from the energy management system (EMS), the user submitted device and usage information, and typical energy consumption data from the database.

The method further includes the step of recommending a more efficient usage style and alternative devices to the user from the database based on a comparison made in the database with the usage of and nature of the associated electronic devices or appliances.

The method further includes the step of communicating from the database to the user a rebate program for the devices in the associated physical and virtual environment as currently offered by utilities and/or retailors.

The database is remote from the user and is communicated with the user through a network.

The method of providing closed-loop feedback from the energy consumption estimate to the users in order to promote energy efficient devices and usage behavior in the associated physical and virtual environment includes the step of communicating with the user through an alert on a mobile communication device, such as a message, a sound, an image, a short video clip and a vibration.

The step of displaying to a remote user, data of power consumption of a plurality of physical and virtual devices in the associated physical and virtual environment based on the current status of each device includes the step of communicating with the remote user through an internet protocol (IP) camera.

The step of retrieving power consumption data with existing product information from the database includes the step of retrieving product information, energy information, incentive programs and user submitted power consumption data.

The step of displaying to the user data of power consumption of a plurality of physical and virtual devices in the associated physical and virtual environment based on the current status of each device includes the step of projecting the data onto a surface collocated with the physical devices and appliances, such as a wall, a screen, a surface of a furniture, a surface of an appliance.

The method further includes the step of mounting actual devices onto a wall for which the data power consumption is displayed on.

The step of providing closed-loop feedback to the users in order to promote energy efficient devices and usage behavior in the associated physical and virtual environment includes the step of controlling the actual and virtual devices in the associated physical and virtual environment by network communication from the user to the database.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is a block diagram of the Wall of Power system showing the projected display on a wall and internet connection into an open database.

FIG. 2 is a depiction of one embodiment of the display of the Wall of Power of FIG. 1 with physical and virtual devices and appliances.

FIG. 3 is a depiction of another embodiment of the display of the of Power of FIG. 1.

FIG. 4 is a depiction of yet another embodiment of the display of the Wall of Power of FIG. 1 on mobile devices.

FIG. 5 is a flow diagram illustrating one protocol for operating the Wall of Power of FIGS. 1-4 with multiple users.

FIG. 6 is a flow diagram illustrating a method of recommending efficient electronic devices and products to users with a database.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

In the illustrated embodiments users interact with a physical-virtual environment while gaining energy consumption knowledge on various choices of electronic appliances and devices. Users have the option to submit voluntary information of their own electronic devices and appliances, and their electrical usage data to a self-aggregating database supporting the physical-virtual front end. The voluntary submission of information about their devices and appliances can be done by photo via smart phone, video, simple text message, etc. The database system and server provide users feedback about their devices' and appliances' current electricity usage, and recommend alternative more energy efficient appliances and devices for upgrade. The existing rebate programs for these devices and appliances offered by utilities and retailers are included in the user feedback.

The invention is a method in which users interact with physical and virtual electronic appliances and devices through a service provided by a self-aggregating database system. Virtual devices, such as electricity appliances and power meters, are superimposed or projected onto a physical screen, display or wall with actual appliances mounted. Internet users access this physical-virtual environment through webcams broadcasting video information. A web service or a mobile application can enable authorized users to gain control of virtual or physical devices. The power consumption of physical and virtual devices is presented to the user based on the current status of each device. The system provides a closed-loop feedback to promote energy efficient products and usage behavior. The users of the system provide information on their own household electronic appliances and devices voluntarily upon signing up for the service. The database system is able to combine retrieved data with existing product information from public and commercial domains. Energy consumption estimation at household level or device level is provided to the users More efficient usage style and alternative devices are regularly recommended to the users.

The illustrated embodiment of the invention includes a method in which users interact with physical and virtual electronic appliances and devices through a service provided by a self-aggregating database system. Virtual devices, such as electricity appliances and power meters, are superimposed or projected onto a physical screen, display or wall with actual appliances mounted. Internet users access this physical-virtual environment through webcams broadcasting video information. A web service or a mobile application can enable authorized users to gain control of virtual or physical devices. The power consumption of physical and virtual devices is presented to the user based on the current status of each device.

The system provides a closed-loop feedback to promote energy efficient products and usage behavior. The users of the system provide information on their own household electronic appliances and devices voluntarily upon signing up for the service. The database system is able to combine retrieved data with existing product information from public and commercial sources. Energy consumption estimation at household level or device level is provided to the users. More efficient usage style and alternative devices are regularly recommended to the users.

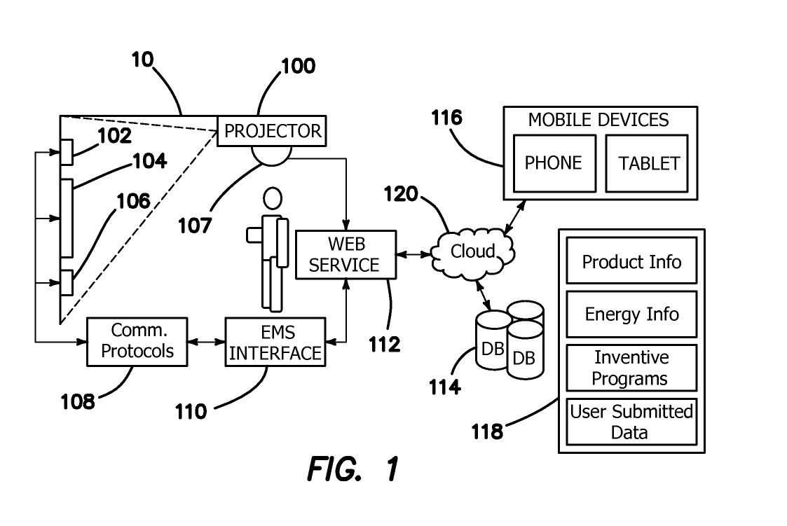

The “Wall of Power” includes three major components: 1) a scalable physical front-end system, 2) a web server/client system, and 3) an open database as schematically shown in FIG. 1, The physical front-end 10 simulates a residential set up of a plurality of consumer electronic devices. Depending on the scale, a single projector or a projector array 100 superimposes backdrop scenes and dynamic energy usage information on the same reflective wall 101 where actual or virtual appliances 102, 104 and 106 are mounted, called the Wall of Power, such as television 102, refrigerator 104 and air conditioner 106. Any plug in or hard-wired electrical power devices or appliances could be monitored and displayed by the front end 10. The web server 112 communicates to users' mobile devices 116 as well as an open database 114 containing product information, energy consumption information, incentive programs and user submitted information.

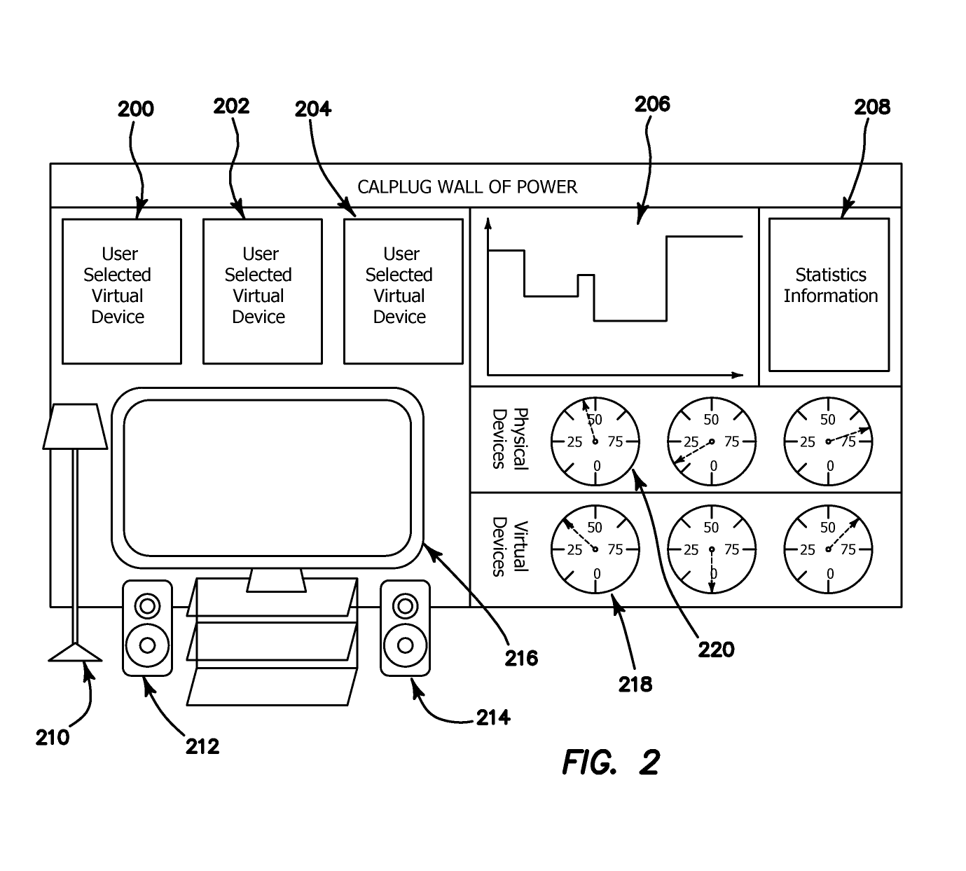

FIG. 2 illustrates one of an innumerable number of possible displays for the Wall of Power. A plurality of user selected, virtual devices 200, 202, and 204 of any nature or variety are depicted on wall 101 in addition to actual devices such as lamp 210, audio stereo 212 and television 216. A real time graph of electrical power usage is provided as graphic feedback in a projected display 206 with a tabular listing of relevant statistical information in projected section 208. Electrical power usages of the actual physical devices is graphically depicted as a simulated electrical meter in projected display 220 with the electrical power usages of the virtual devices graphically depicted as a simulated electrical meter in projected display 218.

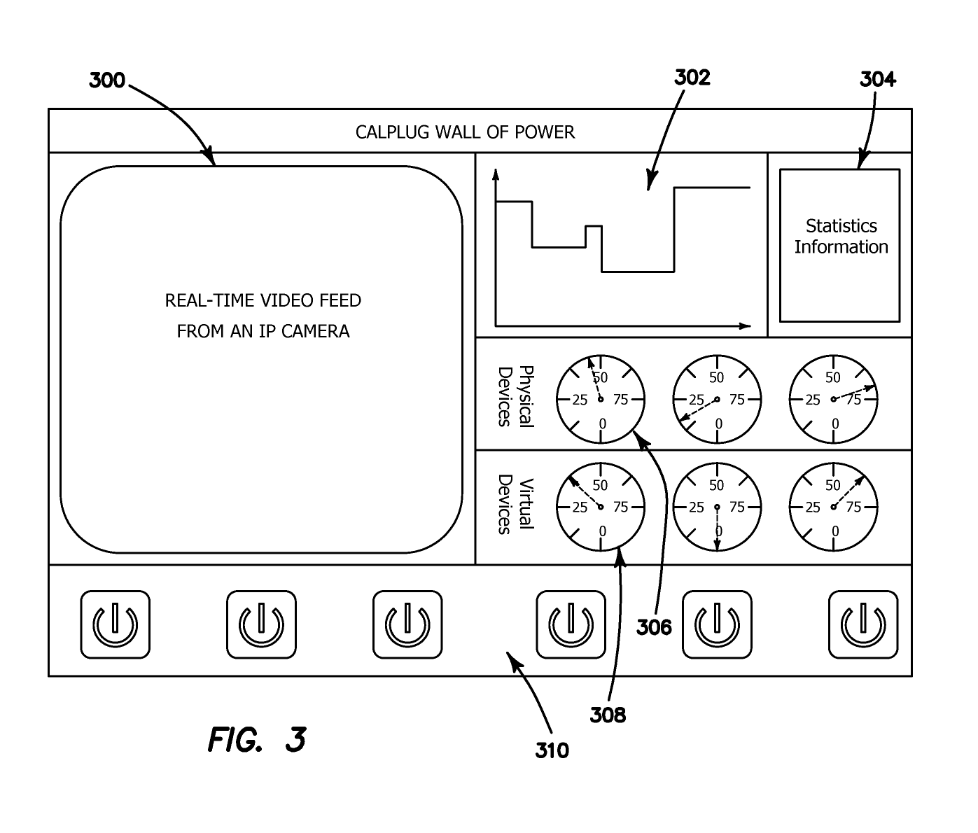

FIG. 3 is an illustration of another embodiment of the display provided by the Wall of Power, which includes the real time or recorded output of an internet protocol (IP) camera in projected display 300. As in the embodiment of FIG. 2, FIG. 3 includes a real time graph of electrical power usage is provided as graphic feedback in a projected display 302 with a tabular listing of relevant statistical information in projected section 304. Electrical power usages of the actual physical devices is graphically depicted as a simulated electrical meter in projected display 306 with the electrical power usages of the virtual devices graphically depicted as a simulated electrical meter in projected display 308. Buttons or scales 310 to control operation modes of devices are arranged for user to interact with the virtual and physical environment.

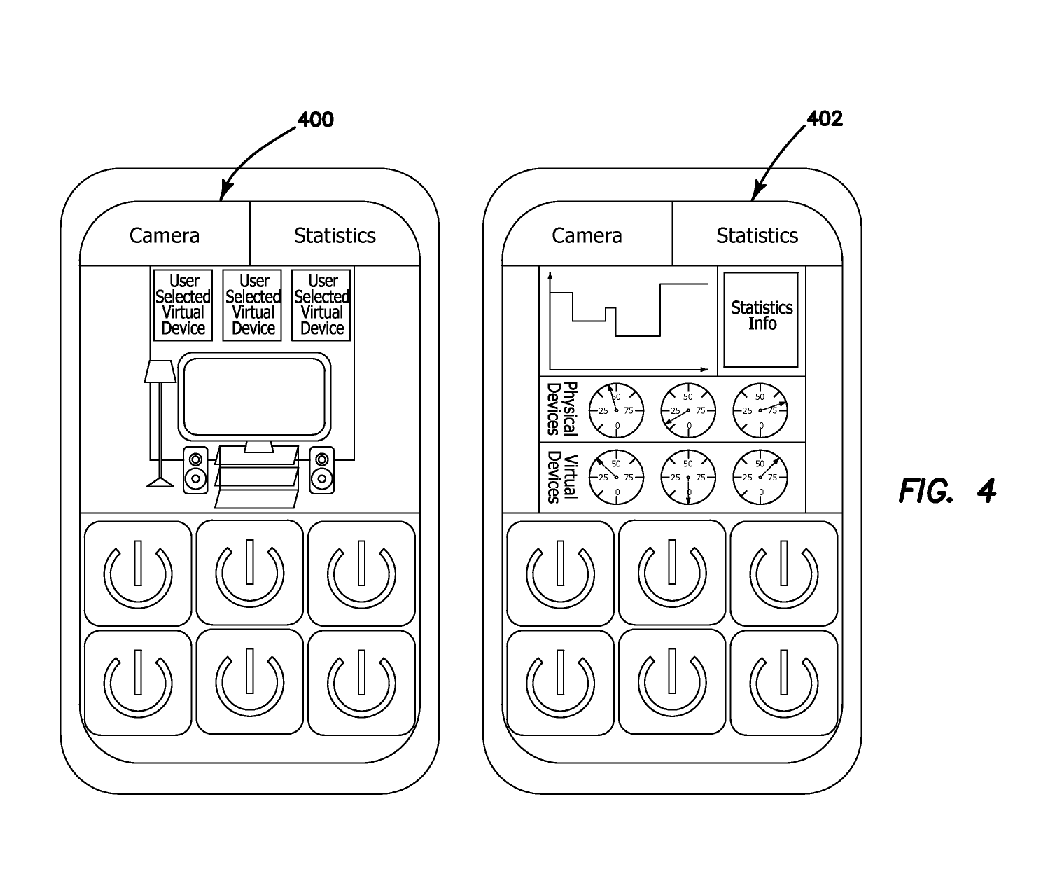

Yet another embodiment of the Wall of Power is illustrated in FIG. 4 where mobile devices are used as displays and controls, displayed either in a camera output display 400 or a statistics output display 402. In the case of the camera output display 400 the left hand portion of the Wall of Power as depicted in FIG. 2 is projected into the viewing window, whereas in the case of the statistics output display 402 the right hand portion of the Wall of Power as depicted in FIG. 2 is projected into the viewing window.

The web server 112 communicates through a bridge or energy management system (EMS) interface 110 to a plurality of wired or wireless communication units 108, such as an X-10 power line communication, VVifi or Zigbee unit, to control and monitor connected appliances 102, 104 and 106. The user gains first-hand knowledge of his or her personal energy footprint (PEF) by interacting with the Wall of Power directly through the web-based router 112 or a Wall of Power mobile application using a smart phone, tablet or laptop 116, using conventional computer input devices, such as a mouse or a touchpad.

Each user is first directed to create a PEF profile by submitting product images through a mobile device enabled by the Wall of Power application. A typical monthly PEF is estimated based on a typical usage pattern. As the user starts to control and use the devices and appliances, the actual energy consumption is compared with the PEF estimation, Instant energy savings can be achieved by turning off unnecessary devices or appliances, or by upgrading to more efficient products through retrieving product information from the CalPlug consumer electronics database. The user is communicated through web server or router 112 to the internet cloud 120 to an open database 114,

Open database 114 and accompanying data aggregation is established at CalPlug to provide users with information on products, energy consumption, incentive programs and to collect user submitted data, symbolically shown as records 118 within database 114. This database 114 utilizes active data mining technologies to retrieve relevant information from public domain information, such as energy programs, consumer electronics retailers and manufacturers, and research institutions. This database 114 is regularly refreshed as new product information becomes available. Consumer initiated voluntary submissions can become a dominant data contributor, as more users sign up for the Wall of Power service.

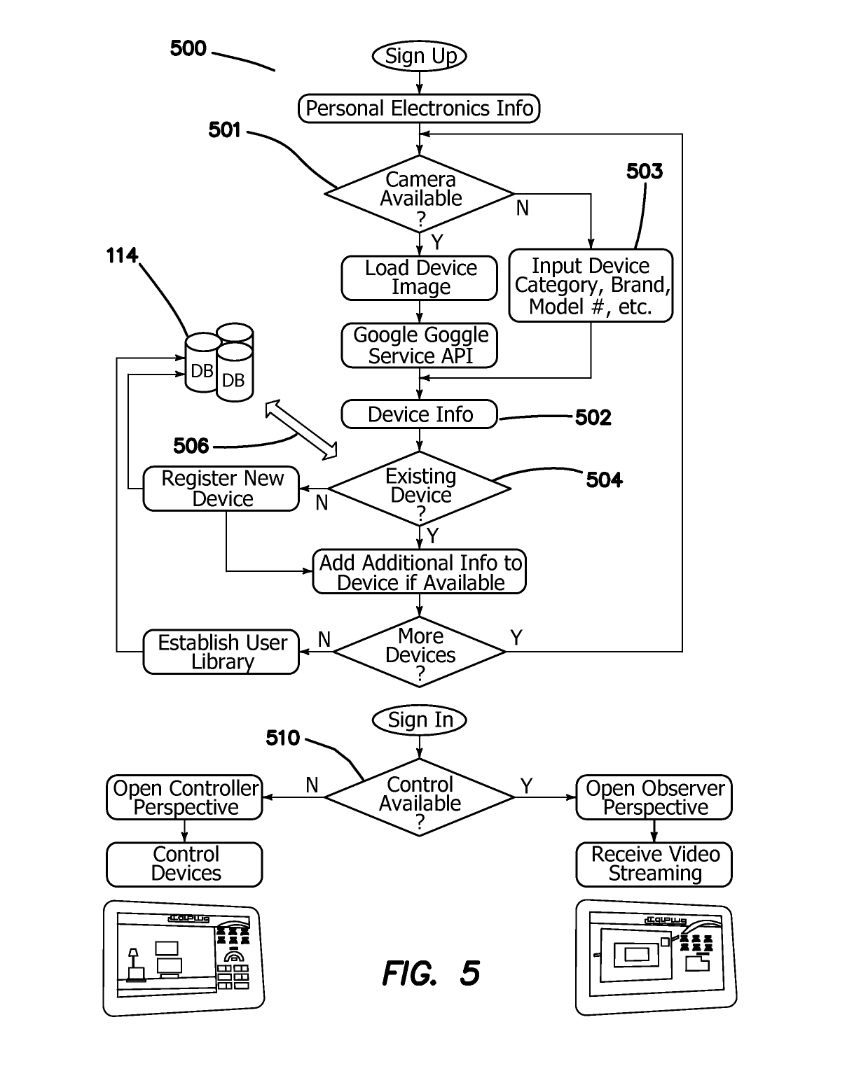

FIG. 5 is a flow diagram of one embodiment of an innumerable number of interaction modes with the Wall of Power that is possible. The user signs up on the system at step 500. If a camera on the device is available 501, an image of the device can be collected. The user can choose to manually input device information as well 503. The user then selects at step 502 the devices or appliances that he or she wishes to manipulate from database 114. A determination is made at step 504 whether the requested device or appliance already exists in the user's environment, real or virtual. If not, then the user uploads the devices or appliance from database 114 into his or her environment at step 506 to return to the selection step 502 thereafter. The environment now being populated with the relevant devices or appliances that the user will employ, the user logs in at step 508. A determination is made at step 510 whether the system is busy or ready to allow user to control devices on the particular Wall of Power, It can be opened in either a controller perspective allowing interactive control by the user or an observer perspective allowing a video stream of data to be viewed.

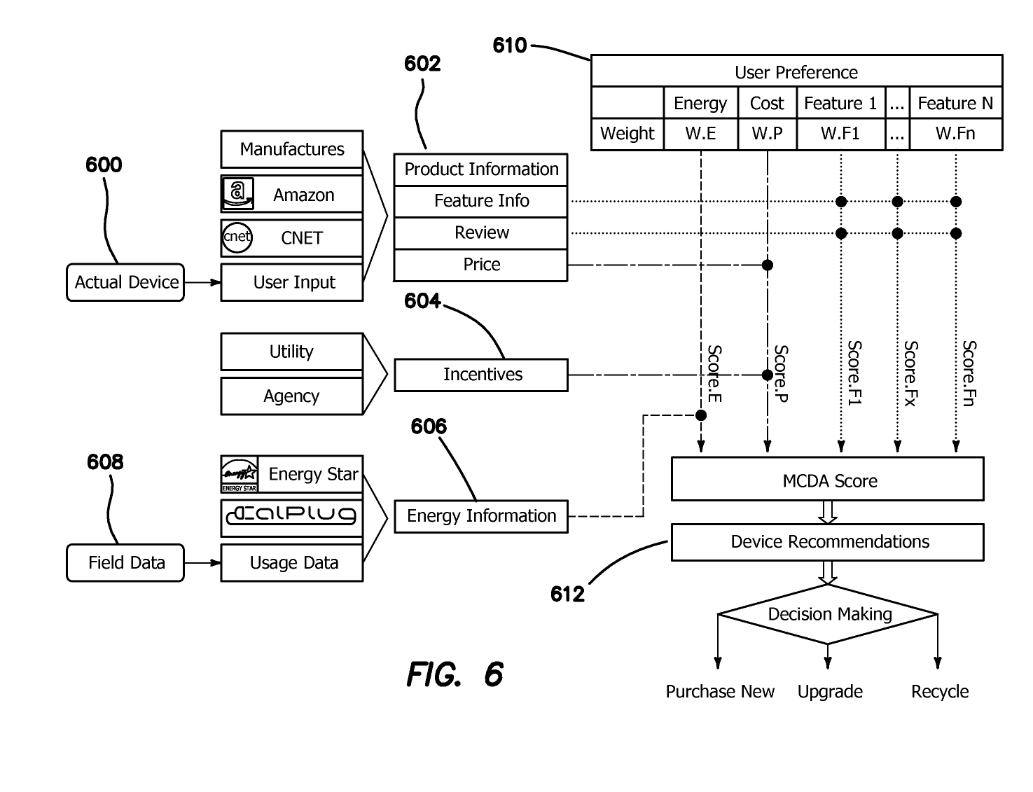

FIG. 6, is a flow diagram of one embodiment of an energy efficient device recommendation method based on the open device database. Product information in step 602, such as features, reviews and price, are retrieved from public or commercial websites, such as Amazon and CNET. User submitted product information from actual devices in household in step 600 can be also uploaded to the database. Incentive programs in step 604 from utilities and agencies are uploaded to the database. Energy consumption information in step 606, such as from Energy Star or testing laboratories, are uploaded to the database Device power consumption, feature, price and incentive programs are weighted and combined to calculate in step 612 the best alternative device according to user preference in step 610. A decision is made in step 614 to purchase a new device, upgrade an old one or to recycle or retain an existing device.

The “Wall of Power” is a highly interactive demonstration of Personal Energy Footprint concept based on the latest electronics, information and database technologies. The efficacy in consumer education is measured with user feedback and surveys conducted online or in person. The user submitted data, either through the internet or by operating the demonstration directly, can become valuable reference for new incentive programs.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

We claim:

1. A system for managing and viewing dynamic energy usage information using an internet communicated to a database having energy consumption data of a plurality of devices or appliances stored therein comprising:
a front end comprising:
a screen, a wall or a surface of a furniture or appliance, on which a display of a plurality of graphical representations of energy consumed by a corresponding plurality of plug load devices is projected;
a projector for projecting the plurality of graphical representations onto the screen;
a router communicated to the internet and to the projector;
an energy management system (EMS) interface coupled to the router; and
at least one plug load device or appliance coupled to, monitored and/or controlled by the energy management system (EMS) interface; and
a mobile communication device communicated by the internet to the database for controlling the front end.

2. The system of claim 1 where the energy management system (EMS) interface further comprises a plurality of wired or wireless communication protocols, such as powerline modem, WiFi and ZigBee radio, coupled to the at least one plug load device or appliance.

3. The system of claim 1 further comprising at least one virtual device or appliance simulated as if coupled to the energy management system (EMS) interface.

4. The system of claim 1 where a plurality of plug load devices or appliances are coupled to, monitored and/or controlled by the energy management system (EMS) interface.

5. The system of claim 1 further comprising a plurality of virtual devices or appliances simulated as if coupled to the energy management system (EMS) interface.

6. The system of claim 1 further comprising a plurality of virtual devices or appliances simulated as if coupled to the energy management system (EMS) interface and where a plurality of plug load devices or appliances are coupled to, monitored and/or controlled by the energy management system (EMS) interface.

7. The system of claim 1 where the mobile communication device is communicated by the internet to the database for uploading into the database consumer initiated voluntary submissions of data relating to power usage.

8. A method of enabling a user of a power consuming devices o acquire energy consumption knowledge comprising:
identifying a user communicating with a database;
associating a physical and virtual environment of power consuming devices with the identified user;
retrieving power consumption data with existing product information from the database;
displaying to the user data of power consumption of a plurality of physical and virtual devices in the associated physical and virtual environment based on the current status of each device; and
providing closed-loop feedback or interactive communication with the user to promote energy efficient devices and usage behavior of the user in the associated physical and virtual environment.

9. The, method of claim 8 where the database is an open database and the users provide device and usage information to the database on their own household devices.

10. The method of claim 8 where the database is an open database and device information, such as power consumption data, features, and price, is obtained from public and commercial sources.

11. The method of claim 8 further comprising providing an energy consumption estimation at a household level based on real time energy report from the energy management system (EMS), typical energy consumption from the database, and user reported device usage information within the associated physical and virtual environment.

12. The method of claim 8 further comprising recommending a more efficient usage style and alternative devices to the user from the database based on a comparison made in the database with the usage of and nature of the associated physical and virtual environment.

13. The method of claim 8 further comprising communicating from the database to the user a rebate program for the devices in the associated physical and virtual environment as currently offered by utilities, government agencies and/or retailers.

14. The method of claim 8 where the database is remote from the user and is communicated with the user through a network.

15. The method of claim 14 where providing closed-loop feedback with the user in order to promote energy efficient devices and usage behavior of the user in the associated physical and virtual environment comprises communicating with the database through a mobile communication device, including by a text message, a sound, a video and/or a vibration.

16. The method of claim 14 where displaying to the user data of power consumption of a plurality of physical and virtual devices in the associated physical and virtual environment based on the current status of each device comprises communicating with the user through an internet protocol (IP) camera.

17. The method of claim 8 where retrieving power consumption data with existing product information from the database comprises retrieving product information, energy information, incentive programs and user submitted power consumption data.

18. The method of claim 8 where displaying to the user data of power consumption of a plurality of physical and virtual devices in the associated physical and virtual environment, based on the current status of each device comprises projecting the data onto a surface, such as a wall, a screen, a surface of an appliance and/or furniture.

19. The method of claim 18 further comprising mounting actual devices onto the wall for which the data power consumption is displayed on the wall.

20. The method of claim 14 where providing closed-loop feedback with the user to promote energy efficient devices and usage behavior of the user in the associated physical and virtual environment comprises controlling the actual and virtual devices in the associated physical and virtual environment by network communication by the user with the database.
